(19) United States
(12) Patent Application Publication
(10) Pub. No.: US 2021/0009263 A1
(43) Pub. Date: Jan. 14, 2021

(54) ROTOR SYSTEM

(71) Applicant: Dotterel Technologies Limited, Auckland (NZ)

(72) Inventors: Samuel Seamus ROWE, Auckland (NZ); Shaun Taggart PENTECOST, Taipuha (NZ); Matthew ROWE, Auckland (NZ); Shaun Michael EDLIN, Auckland (NZ); Young-min SHIM, Auckland (NZ); Michael KINGAN, Auckland (NZ); Ryan MCKAY, Auckland (NZ); Sung-Tyaek Go, Auckland (NZ)

(21) Appl. No.: 16/926,416

(22) Filed: Jul. 10, 2020

(30) Foreign Application Priority Data
Jul. 12, 2019 (NZ) 755332

(51) Int. Cl. B64C 27/82; B64C 39/02; B64C 27/20

(52) U.S. Cl. CPC B64C 27/82; B64C 39/024; B64C 27/20; B64C 2201/108; B64C 2201/042; B64C 2027/8227; B64C 2201/14

(57) ABSTRACT

According to an example embodiment there is provided an unmanned aerial vehicle (UAV), the UAV including: a first rotor, the first rotor having a diameter and a first number of blades; and a second rotor, the second rotor having a diameter and a second number of blades; wherein the first and second rotor are substantially coaxial; and wherein the first number and the second number are not the same number and are both more than one.

### CROSS REFERENCE TO RELATED APPLICATIONS

The present application claims priority to New Zealand Application No. 755332 filed with the Intellectual Property Office of New Zealand on Jul. 12, 2019 and entitled “A ROTOR SYSTEM,” which is incorporated herein by reference in its entirety for all purposes.

### FIELD

This invention relates to a rotor system for an unmanned aerial vehicle (UAV), such as a drone, and in particular to an efficient and quiet drone rotor system.

### BACKGROUND

Although contra-rotating rotors with different diameters have been used in full-sized aircraft or other UAVs, previous use has been restricted to configurations where the outer diameter of the upstream rotor is larger than the outer diameter of the downstream rotor. Previous aeronautical theory may suggest that the tip vortex shed from the top/upstream propeller interacting with the bottom/downstream propeller causes significant unsteady loading on the downstream propeller and resulting noise. Cropping the bottom/downstream propeller reduces or eliminates the interaction of the vortex with the downstream propeller and thus this noise source. Conversely, based on previous aeronautical theory a contra-rotating propeller with a smaller top/upstream propeller might be expected to result in a strong tip vortex interaction and thus high levels of noise.

### SUMMARY

According to one example embodiment there is provided an unmanned aerial vehicle (UAV), the UAV including an upstream rotor having a first diameter, and a contra-rotating downstream rotor having a second diameter larger than the first diameter.

According to a second example embodiment there is provided an unmanned aerial vehicle (UAV), the UAV including: a first rotor, the first rotor having a diameter and a first number of blades; and a second rotor, the second rotor having a diameter and a second number of blades; wherein the first and second rotor are substantially coaxial; and wherein the first number and the second number are not the same number and are both more than one.

According to a further embodiment, there is provided the unmanned aerial vehicle of the second example embodiment, wherein the first and second rotor are attached to shafts. The shafts may be substantially co-axial. Alternatively, the shafts may be separated by a radial separation less than 10% of the diameter of the first or second rotor.

According to a third example embodiment there is provided a method for operating a contra-rotating rotor assembly of an unmanned aerial vehicle (UAV), the method including: selecting an operating mode from the group consisting of an efficiency mode, low noise mode or any combination thereof; determining a first operating speed for an upstream rotor and a second different operating speed for a contra-rotating downstream rotor, wherein the first operating speed and the second operating speed are based on the selected operating mode; and driving the upstream rotor at the first operating speed and the contra-rotating downstream rotor at the second operating speed.

According to a still further embodiment, there is provided the method of the third example embodiment, wherein the operating mode is selected using a user interface.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements. Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 depicts a block diagram of the electronics of an unmanned aerial vehicle (UAV);

FIG. 2 depicts one example of a UAV, particularly a quadcopter;

FIG. 3 depicts a rotor assembly used in a UAV;

FIGS. 4a-c depict different driving arrangements used in a rotor assembly;

FIG. 5 depicts a non-concentric rotor assembly;

FIG. 6 depicts a rotor assembly using a two-blade/three-blade configuration;

FIG. 7 depicts the thrust versus input power for a variety of different sized rotors;

FIG. 8 depicts the overall sound pressure level versus thrust for a variety of different sized rotors;

FIG. 9a-b depict the noise profile and directionality of a two-blade/two-blade configuration; and

FIG. 10a-b depict the noise profile and directionality of a three-blade/two-blade configuration;

FIG. 11 depicts a method of operating a contra-rotating rotor assembly; and

FIG. 12 depicts a method of determining a first and second speed of a first and second motor of a contra-rotating rotor apparatus.

### DETAILED DESCRIPTION

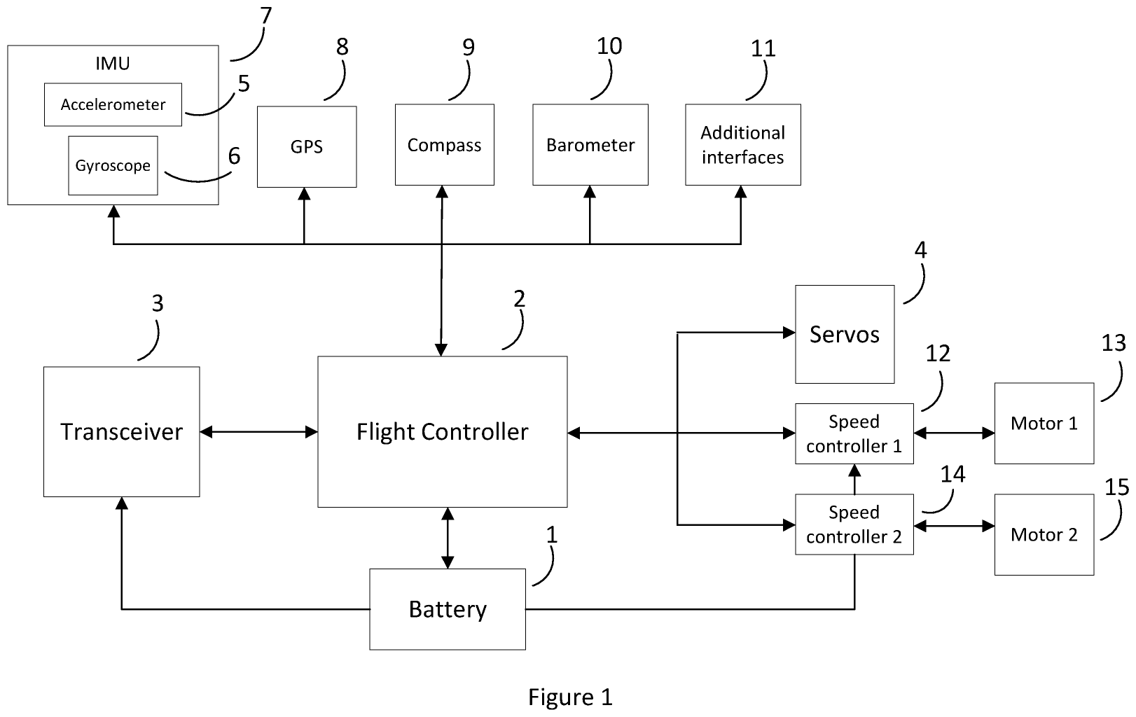

FIG. 1 shows a block diagram of the electronics of an unmanned aerial vehicle (UAV) according to one example embodiment. The UAV includes a battery 1 or other power source which powers the on-board components of the UAV. A flight controller 2 is used to control the different on-board components of the UAV and receives commands from the operator of the UAV via transceiver 3. In some embodiments, the transceiver 3 may be in communication with a remote control apparatus or interface, such as radio control, operated by the UAV operator. In other embodiments, the transceiver 3 may be in communication with a ground station or other computer device.

The flight controller 2 may communicate with and control servos 4, which can be used to make adjustments to the pitch, yaw, or roll of the UAV. In some embodiments, the UAV may include additional servos to control other components, such as a gimbal for a microphone and/or image capturing device, depending on the application of the UAV.

The flight controller 2 may receive information from multiple sensors on-board the UAV. These sensors may include an accelerometer 5 and gyroscope 6, which may be included as separate sensors on-board the UAV or packaged as a single sensor, such as an IMU (inertial measurement unit) 7. The flight controller may also be in communication with an on-board GPS transceiver 8, which enables GPS functionality for the UAV, and/or compass 9, which allows the UAV operator to measure the bearing of the UAV. In some embodiments, the UAV may also include a barometer 10, which may be used to approximate the altitude of the UAV by measuring the pressure of the air in the immediate vicinity of the UAV. The UAV may also include additional interfaces 11 to be used with additional sensors or modules, such as microphones or image capturing devices, depending on the application of the UAV. In some embodiments, all of the on-board sensors may relay their measurements back to the operator of the UAV via the on-board transceiver 3.

The UAV may also include one or more speed controllers 12 and 14, such as ESCs (electronic speed controllers), which are used to control the speeds of motors 13 and 15. Although the embodiment depicted in FIG. 1 includes two speed controllers 12 and 14 and two motors 13 and 15, the number of motors and the number of associated speed controllers may vary depending on the application of the UAV. In some embodiments, each motor may have a dedicated speed controller to control its speed. In other embodiments, one of a plurality of motors may be in communication with multiple speed controllers. In other embodiments, a single speed controller may be used to control several motors. Furthermore, in embodiments with several motors, the one or more speed controllers may be configured to drive the motors at different speeds.

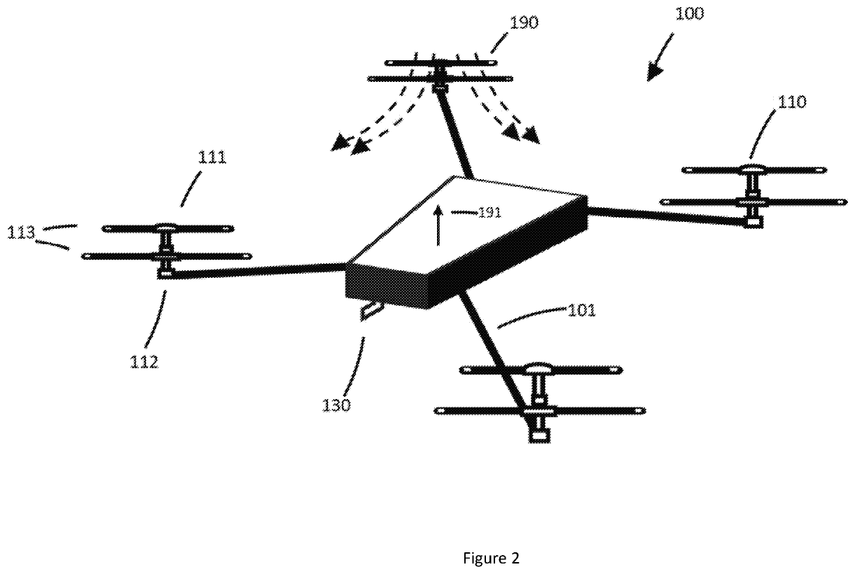

FIG. 2 depicts an unmanned aerial vehicle (UAV) according to one example embodiment. The UAV 100 includes a plurality of rotor assemblies 110 which may be spaced some distance away from the center of the UAV by arms or struts 101. In some embodiments, each rotor assembly 110 may include a plurality of rotors 111 and 112, and each rotor 111 and 112 may in turn include one or more blades or propellers 113.

When the UAV 100 is in use, one or more of the rotor assemblies 110 is powered or driven by a motor or other means via one or more on-board speed controllers (not shown), causing the individual rotors 111 and 112 and their associated blades or propellers 113 to rotate at a particular speed, usually measured in revolutions per minute (RPM). The blades or propellers 113 are typically shaped to direct or displace air when rotated, causing air 190 to be drawn through the rotor assembly 110 in a generally downwards direction. The equal and opposite effect of air 190 being drawn through the rotor assembly 110 causes the UAV 100 to experience a lift or thrust 191 proportional to the rate of air 190 displaced by the rotor assembly 110, allowing the UAV 100 to take flight.

In embodiments where a high thrust-to-rotor-volume is desirable, the individual rotors 111 and 112 within each rotor assembly 110 may be contra-rotating. In these embodiments, the direction of rotation of rotor 111 is opposite to the direction of rotation of rotor 112. For example, in a single rotor assembly 110, the upstream rotor 111 may rotate clockwise, while the downstream rotor 112 may rotate counter-clockwise.

The operation of the rotor assembly 110 to create a lift force or thrust 191 may create unwanted noise, which is undesirable for a number of applications. For example, when the UAV 100 is operated in a residential area or other location where people are in the immediate vicinity, people may perceive the noise created by the UAV 100 to be irritating or intrusive, and the UAV may contribute to the overall noise pollution in that area. In a further example, UAVs are often used to record video and audio for cinematographic purposes or otherwise, and the noise generated by the UAV 100 may interfere with or overwhelm the audio which is intended to be recorded.

In particular, each blade or propeller 113 may generate noise as it moves and applies forces to the air. This is especially pronounced at the tip of each blade 113, where vortices may form as the blade 113 rotates. In embodiments where each rotor assembly 110 includes more than one rotor 111 and 112, the airflows and blade-tip vortices created by each respective rotor 111 and 112 may interact with one another. These interactions are especially pronounced when the individual rotors 111 and 112 are contra-rotating. The use of contra-rotating rotors can therefore introduce significant complexity in the noise profile generated by the UAV, which may vary significantly depending on the speed or RPM of each individual rotor 111 and 112. The noise generated by UAV 100 may be highly directional. Noise will be generated in all directions, however, in some instances noise may be loudest at angles close to the axis of rotation of each propeller. The noise perceived by a person or other entity on the ground will therefore depend on where the person or other entity is in relation to the UAV 100 and the noise profile of the UAV 100. Likewise, the noise level at the position of an element or component attached to the UAV 100, for example a microphone 130, will depend on where the element or component is positioned in relation to the rotor assembly 110.

Additionally, the power source used to power the one or more motors or other driving means (not shown) is typically contained within or onboard the UAV 100, and must be capable of containing enough energy for the UAV to perform its function or flight mission and safely travel or return to a designated spot. For instance, the power source may consist of a battery which is contained within the UAV 100, and which can only be recharged once the UAV has returned to its operator on the ground. If the rotor assembly 110 consumes too much energy over the course of the UAV's flight mission, the internal battery may be left with insufficient power mid-flight to continue driving the rotor assembly 110. The efficiency of rotor assembly 110—typically defined as the amount of lift force or thrust outputted by the rotor assembly 110 for a given input power—at least partially defines how long the UAV may be safely operated for before the power source requires recharging.

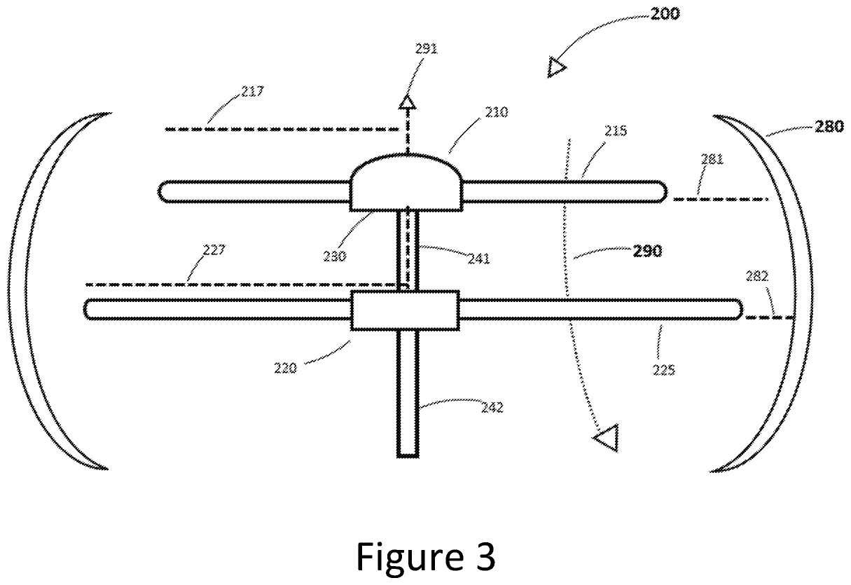

FIG. 3 illustrates a contra-rotating rotor assembly for a UAV according to one embodiment. The illustrated rotor assembly 200 includes an upstream rotor 210 and a downstream rotor 220. The upstream rotor 210 and downstream rotor 220 are separated by a separation 230. The upstream rotor 210 has one or more blades 215, while the downstream rotor 220 has one or more blades 225. In some embodiments, the UAV may further include a shroud or cowling 280 at least partially surrounding the upstream rotor 210 and/or downstream rotor 220.

When in use, the upstream rotor 210 rotates in a first direction, which in this non-limiting example is depicted in the clockwise direction. The downstream rotor 220 contra-rotates in a second direction contrary to the first direction, which in this non-limiting example is depicted in an anti-clockwise direction. The upstream rotor 210 and downstream rotor 220 are therefore contra-rotating. It will be appreciated that the depicted direction of rotation in this example is for illustrative purposes only, and the upstream rotor 210 may be capable of rotating in either direction, provided that the downstream rotor 220 contra-rotates relative to the first rotor 210. The contra-rotation of the upstream and downstream rotors 210 and 220 draws air 290 through the rotor assembly in a generally downwards direction, generating a lift force or thrust. The upstream rotor 210 is disposed upstream relative to the airflow 290, while the downstream rotor 220 is disposed downstream relative to the airflow 290. It will be appreciated that ‘upstream’ and ‘downstream’ are used herein relative to the airflow 290 as defined when the rotor assembly 200 is generating a positive lift force. Although the rotor assembly 200 may be capable of reversing its rotation to generate an airflow opposite to the airflow 290 depicted in this non-limiting example (corresponding to a negative lift force), the upstream rotor 210 will still be described as being upstream relative to the downstream rotor 220.

The blades 215 belonging to the upstream rotor 210 define a first rotor diameter 217 as the terminating ends of the blades sweep out a circle. Similarly, the blades 225 belonging to the downstream rotor 220 define a second rotor diameter 227. In some embodiments, the second diameter 227 is larger than the first diameter 217. The applicant has found that when the second diameter 227 is larger than the first diameter 217, the efficiency of the rotor assembly 200—that is, the thrust or lift force generated by the rotor assembly 200 for a given power—is greater than when the first and second diameters 217 and 227 are equal, or when the first diameter 217 is larger than the second diameter 227. Additionally, the applicant has found that the noise produced by the rotor assembly 200 may be minimized when the second diameter 227 is larger than the first diameter 217.

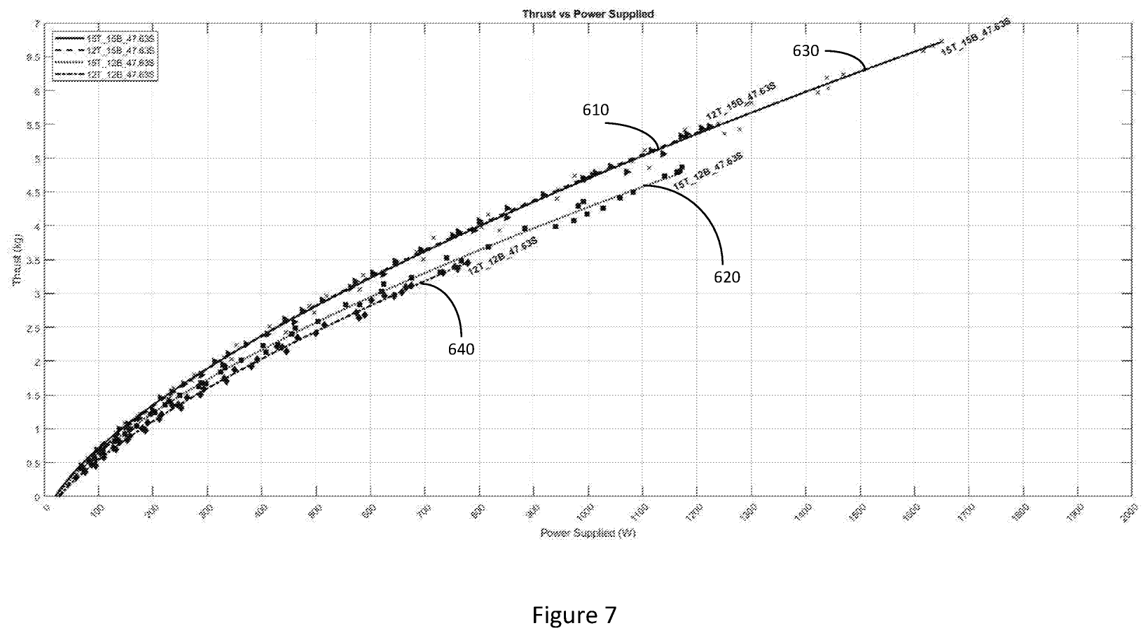

To illustrate how the efficiency of a contra-rotating rotor assembly varies with the diameter of the individual upstream and downstream rotors, FIG. 7 depicts the output thrust versus input power for several different rotor configurations. Both 15″ rotors and 12″ rotors were investigated in the following upstream/downstream configurations:
12″/15″ upstream/downstream (610)
15″/12″ upstream/downstream (620)
15″/15″ upstream/downstream (630)
12″/12″ upstream/downstream (640)

The input power is distributed between the two rotors for a given configuration. Each of the two rotors are driven independently and may rotate at different speeds in a given configuration, although the absolute difference between their speeds is capped at 1000 RPM.

The 12″/15″ configuration 610 typically yields more thrust for a given input power than other configurations, although the 15″/15″ configuration 630 may exhibit a marginally higher efficiency between 0 to 250 W of input power. In comparison, the 15″/12″ configuration 620 is considerably less efficient than either the 12″/15″ or 15″/15″ configurations 610 and 630. This is a surprising result, given that conventional theory would predict the 15″/12″ configuration to yield the highest efficiency. Furthermore, the 12″/12″ configuration 640 yields the lowest efficiency of all configurations shown here.

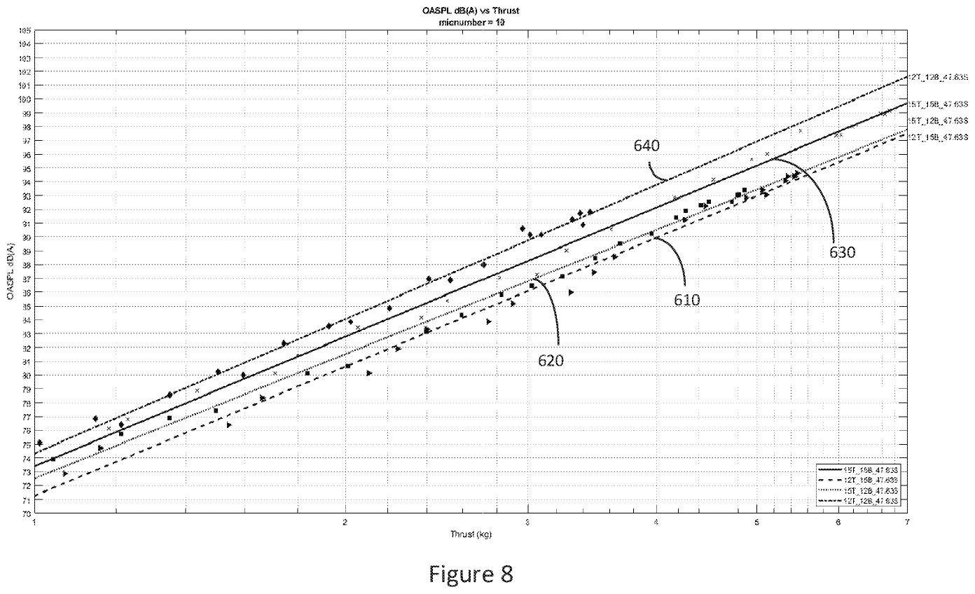

FIG. 8 depicts the overall sound pressure level (OASPL) for a given lift force or thrust of each of the rotor configurations investigated in FIG. 7. The OASPL for each configuration is measured 135° from the axis of the rotor assembly (with 0° pointing coaxially upstream and 180° pointing coaxially downstream) as UAVs may be typically heard from this angle by people on the ground. The OASPL has also been A-weighted in accordance with international standard IEC 61672:2014. It can be seen that the 12″/15″ configuration 610 is quieter than all other configurations for a given thrust value. In comparison, the 15″/15″ configuration 630 is approximately 1.5-2 dB louder than the 12″/15″ configuration 610 at all thrust values. The 15″/12″ configuration 620 is also louder than the 12″/15″ configuration 610, although the difference in the noise between the two configurations becomes smaller with increasing thrust. The 12″/12″ configuration 640 is the noisiest of all configurations investigated here.

Both FIGS. 7 and 8 clearly illustrate some of the advantages in using an upstream rotor having a first diameter and a contra-rotating downstream rotor having a second diameter larger than the first diameter. Despite parallels between contra-rotating UAV-sized and full-sized rotors, the 12″/15″ configuration 610 surprisingly outperforms the 15″/12″ configuration 620 in both maximum efficiency and minimum noise production. Furthermore, the 12″/15″ configuration 610 depicted here is at least as efficient as the 15″/15″ configuration 630 at lower input powers and outperforms all other configurations at higher input powers. Additionally, the 12″/15″ configuration 610 also produces the lowest OASPL at 135° for any given thrust. In particular, the 12″/15″ configuration 610 is significantly quieter than the 15″/15″ configuration 630, which contends with the 12″/15″ configuration 610 for a similar efficiency.

With reference to FIG. 3, in some embodiments of the rotor assembly 200, the ratio of the first diameter 217 to the second diameter 227 may be 1:1.05-1.5. In further embodiments, the first diameter 217 may be 12″-12.5″, while the second diameter 227 may be 15″.

In some embodiments, the separation 230 may be between 18 mm and 48 mm. In other embodiments, the separation 230 may be chosen as a proportion to the first or second diameter 217 and 227. As a non-limiting example, the separation 230 may be expressed as 0.5*D1, where D1 is the first diameter 217.

In some embodiments, the number of blades 215 and 225 may differ. In one embodiment, the upstream rotor 210 may have 2 blades, while the downstream rotor 220 may have 3 blades. In another embodiment, the upstream rotor 210 may have 3 blades, while the downstream rotor 220 may have 2 blades. In other embodiments, the number of blades 215 and 225 may be identical.

In some embodiments, other aspects of the blades 215 and 225 belonging to the upstream and downstream rotor 210 and 220 may differ. As a non-limiting example, aerofoil geometry such as the pitch, chord, camber, camber line, angle of attack, and thickness of the blades 215 belonging to the upstream rotor 210 may differ from the blades 225 belonging to the downstream rotor 220. The individual blades belonging to a single rotor or between rotors may differ depending on the application.

In embodiments where a shroud or cowling is used to at least partially surround the upstream rotor 210 and/or the downstream rotor 220, a first clearance 281 may be defined between the first blades 215, and a second clearance 282 may be defined between the second blades 225. The interacting airflows generated by each rotor 210 and 220 may also interact with an inner surface of the shroud or cowling 280, and the size of the clearances 281 and 282 may affect these interactions. In some embodiments, the size of the clearances 281 and 282 may be chosen to increase the efficiency of (or decrease the noise generated by) the rotor assembly 200. The upstream rotor 210 may be attached or operably coupled to a first shaft or driving means 241, while the downstream rotor 220 may be attached or operably coupled to a second shaft or driving means 242. The first and second shaft or driving means 241 and 242 are in turn driven or powered by one or more motors or other means via one or more on-board speed controllers (not pictured). In some embodiments, the first shaft or driving means 241 and second shaft or driving means 242 are substantially co-axial.

The first and second shaft or driving means 241 and 242 may be independent of one another, allowing the upstream rotor 210 to be driven at a first speed independent of the downstream rotor 220 which may be driven at a second speed. In some embodiments, although the first and second shaft or driving means 241 and 242 are independent, the upstream and downstream rotor 210 and 220 may rotate at identical speeds, albeit in contrary directions. In other embodiments, the upstream rotor 210 may rotate at a different speed to the downstream rotor 220. In these embodiments, the UAV may include one or more speed controllers configured to rotor the upstream rotor 210 at a different speed to the downstream rotor 220. In yet a further embodiment, the first and second shaft or driving means 241 and 242 may not be independent, and the upstream and downstream rotor 210 and 220 may be fixed to rotate in contrary directions at the same speed. Although the embodiment of the rotor assembly 200 depicted in FIG. 2 utilizes shafts to power or drive each rotor 210 and 220, this is for illustrative purposes only, and is not intended to be limiting. Other powering or driving means may be utilized to power either of both of the upstream and downstream rotors 210 and 220. As a non-limiting example, one or more rotors may be directly coupled to the rotor of a motor (not shown). The rotor may be powered or driven according to the requirements of the application.

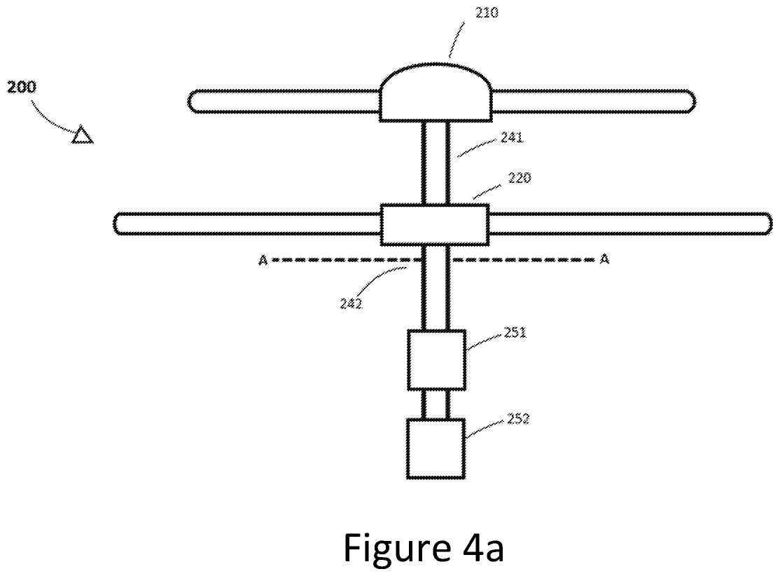

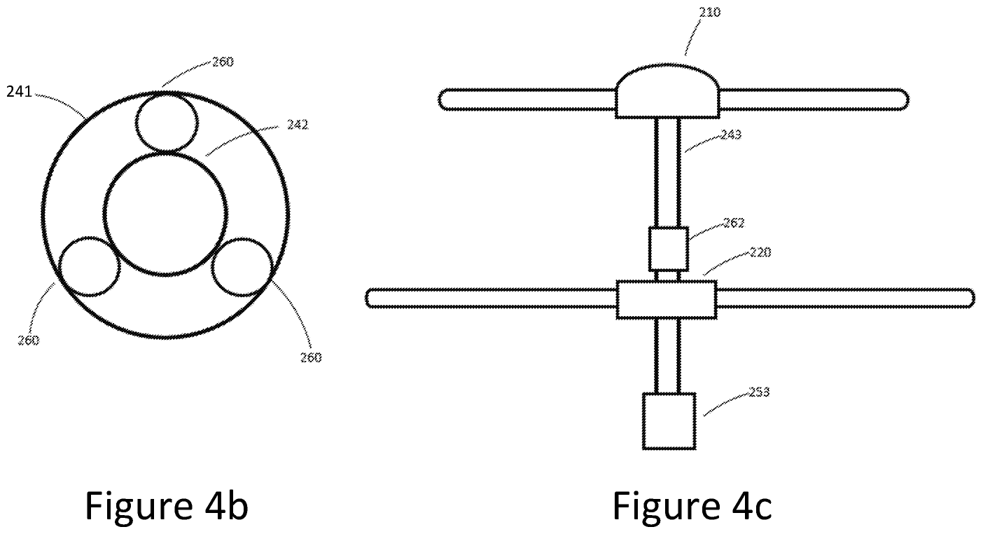

FIGS. 4a-c depict various non-limiting embodiments of driving arrangements used to drive or power the rotor assembly 200. In the non-limiting embodiment depicted in FIG. 4a, the upstream rotor 210 is operably coupled to a first shaft 241 which is driven by motor 251, while the downstream rotor 220 is operably coupled to a second shaft 242 which is driven by a motor 252. The first shaft 241 and second shaft 242 may be substantially co-axial. In this non-limiting embodiment, the first and second shaft 241 and 242 are independent of one another, allowing the speed of each rotor 210 and 220 to be independently determined by their associated motor 251 or 252. The first and second shaft 241 and 242 may be concentric or coaxial, but still may rotate independently of one another.

FIG. 4b depicts the cross-section A-A indicated in FIG. 4a. The shafts 241 and 242 are concentric about one another, with the outer surface of the concentric shaft arrangement defined by shaft 241, and the inner surface of the concentric shaft arrangement defined by shaft 242. One or more bearings 260 may be disposed at one more or locations between the inner and outer surface of the concentric shaft arrangement, allowing the first and second shaft 241 and 242 to rotate independently of one another. This allows the upstream rotor 210, which is operably coupled to the first shaft 241, to rotate at an independent speed and direction of the downstream rotor 220, which is operably coupled to the second shaft 242. The bearing 260 disposed between the shafts 241 and 242 may depend on the application, and various ways in which two independently-driven shafts may be arranged to be concentric may be used.

In a further embodiment depicted in FIG. 4c, the upstream and downstream rotor 210 and 220 may be operably coupled to a single shaft 243, which may be driven or powered by a single motor 253. In these embodiments, contra-rotation of the upstream rotor 210 with respect to the downstream rotor 220 may be achieved by a gearing arrangement 262 or other means. As a non-limiting example, the gearing arrangement may include one or more planetary or epicyclic gears or gear trains. In some embodiments, the gearing arrangement 262 may be disposed in between the upstream and downstream rotor 210 and 220, bifurcating the shaft 243 into one portion which rotates in a given direction above the gearing arrangement 262, and into another portion which rotates in a contrary direction below the gearing arrangement 262.

In another embodiment, a portion of the engaging components of the gearing arrangement 262 may be disposed on the shaft where the upstream or downstream rotor is disposed, and may engage with another portion of engaging components which form part of the rotor 210 or 220. As a non-limiting example, one half of a planetary or epicyclic gear train may be disposed on the shaft 243, and the other half of the planetary or epicyclic gear train may be disposed within the hub or center of one of the rotors 210 or 220. Each respective half of the planetary or epicyclic gear train may engage with the other half, allowing the rotor including the half of the gear train to rotate in a contrary direction to the rotation of the shaft 243. In these exemplary embodiments, the entire shaft 243 would rotate in a single direction, while the rotor which includes half of the gear train would rotate contrary to the shaft 243.

The motors 251-253 in the above embodiments may be brushless DC motors, or any other motor suitable for powering the rotor of a UAV. Different motors can be employed to drive the rotors of a UAV depending on the application.

Different motor arrangements may also be used depending on the application. Although two motors 251 and 252 are depicted in the above embodiment where each rotor 210 and 220 are independently driven, more than two motors may be used. In alternative embodiments, a single motor may be used to drive both shafts 241 and 242, even when shafts 241 and 242 are capable of being independently driven. Similarly, although a single motor 253 is depicted in driving the single drive shaft 243, more than one motor may be used in some embodiments.

Moreover, although the motors 251-253 are depicted as being downstream of rotors 210 and 220 in the above illustrations, this is not intended to be limiting. In some embodiments, the motor or motors used to drive the rotors 210 and 220 may be upstream or downstream of one or more of the rotors 210 and 220. In some embodiments, one or more motor may be disposed between the rotors 210 and 220, being upstream of one rotor and downstream of another.

In embodiments where the UAV includes a shroud or cowling which at least partially surrounds the upstream rotor 210 and/or downstream rotor 220, the motors may also be at least partially enclosed or surrounded by the shroud or cowling. In other embodiments, the motors may be disposed outside of the shroud or cowling and may not be enclosed.

In yet another embodiment, the motors used to drive the rotors 210 and 220 may be disposed on the body of the UAV or in another location which is not coaxial or concentric with the rotor assembly 200, and power or drive may be supplied to one or more shafts through an intermediary shaft or gearing arrangement. The one or more motors may be disposed relative to the rotor assembly 200 depending on the application.

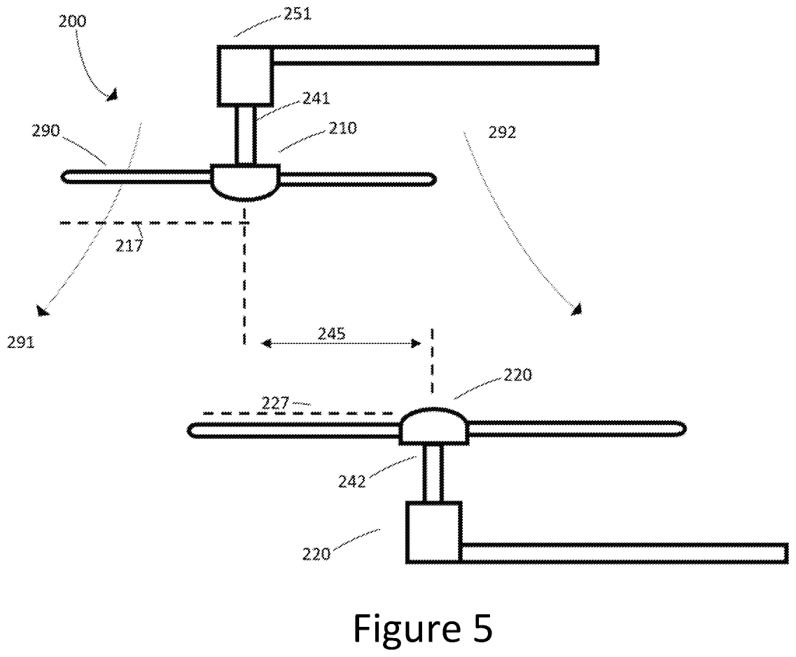

FIG. 5 depicts an alternative embodiment of the rotor assembly 200. In this embodiment, the upstream rotor 210 is not completely coaxial or concentric with the downstream rotor 220. As before, the upstream rotor 210 may have a first diameter 217 which is smaller than the second diameter 227 of the downstream rotor 220. In these embodiments, at least a portion 291 of the air 290 drawn through the upstream rotor 210 may also be drawn through the downstream rotor 220. Due to the offset between the upstream and downstream rotors 210 and 220, a portion of air drawn through the upstream rotor 210 may not pass through the downstream rotor 220. Similarly, the downstream rotor 220 may draw in a portion of airflow 292 which does not pass through the upstream rotor 210.

In embodiments where the upstream and downstream rotors 210 and 220 are offset, the respective shafts 241 and 242 may be substantially parallel and separated by a separation 245, as depicted in FIG. 5. In some embodiments, the separation 245 may be chosen as a fraction of the diameter of the first upstream rotor 210 or second downstream rotor 220. In one embodiment, the separation 245 may be radial (e.g. substantially tangential to the axes of the shafts), and chosen to be less than 10% of the first diameter 217 of the upstream rotor 210 or the second diameter 227 of the downstream rotor 220.

In other embodiments, the respective shafts 241 and 242 may be at least partially concentric and may include a bend or angle to achieve an offset between the rotors 210 and 220. The geometric relationship between the shafts 241 and 242 and motors 251 and 252 depicted in FIG. 5 may depend on the application, and there are various ways in which the shaft or shafts and motor or motors may be positioned to allow for an offset between the upstream and downstream rotors 210 and 220.

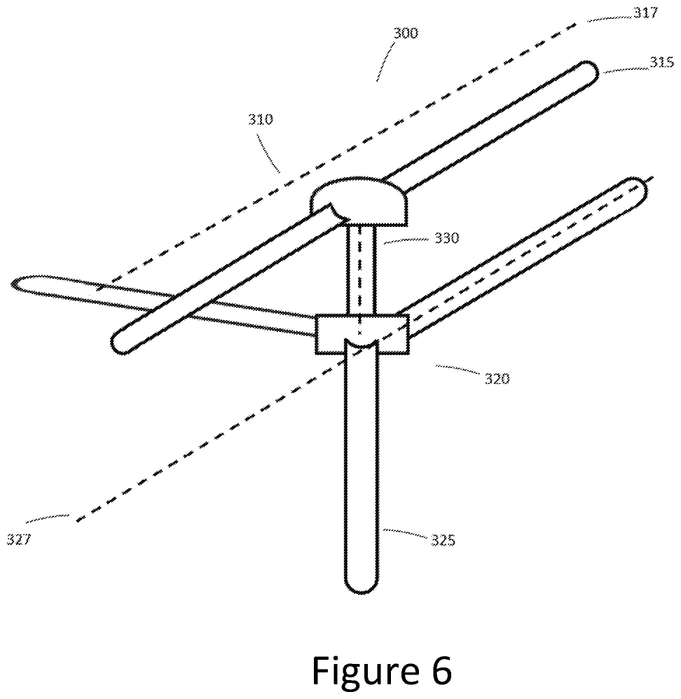

According to another embodiment, FIG. 6 depicts a rotor assembly including a two-blade/three-blade arrangement used with a UAV. In this non-limiting example, the rotor assembly 300 includes a first rotor 310 and a second rotor 320 which are coaxial. In this particular embodiment, the first rotor 310 is upstream of the second rotor 320, although in other embodiments the first rotor 310 may be downstream of the second rotor 320. The first and second rotors 310 and 320 are separated by a separation 330 along their shared axis. In use, the first and second rotors 310 and 320 may be contra-rotating. In some embodiments, the first rotor 310 and second rotor 320 may be capable of rotating at different speeds, and the UAV may include one or more on-board speed controllers configured to rotate the first rotor 310 and second rotor 320 at different speeds. Furthermore, in some embodiments, the UAV may further include a shroud at least partially surrounding the first rotor 310 and/or second rotor 320.

The first rotor 310 includes one or more blades 315, while the second rotor 320 also includes one or more blades 325. In some embodiments, the number of blades 315 belonging to the first rotor 310 is two, while the number of blades 325 belonging to the second rotor 320 is three. In other embodiments, the number of blades 315 belonging to the first rotor 310 is three, while the number of blades 325 belonging to the second rotor 320 is two.

The applicant has found that using one rotor having three blades in conjunction with another contra-rotating rotor having two blades can significantly reduce the noise produced by the contra-rotating rotors.

By way of background, the noise produced by a contra-rotating rotor system contains tones which occur at integer multiples of the sum and difference of the blade passing frequency of each rotor. The blade passing frequency (BPF) of a rotor corresponds to the number of times per second a blade passes a point on the rotor's circumference, and therefore depends on both the number of blades belonging to that rotor and how many revolutions the rotor completes per second. Adjusting the speed of the rotor or changing its blade number correspondingly changes the rotor's blade passing frequency.

To date, contra-rotating systems employed in full-scale aircraft utilize rotors with large blade numbers and a significant blade number difference—for example, one contra-rotating system which has previously been considered uses a first upstream rotor with 12 blades and a second downstream rotor with 9 blades. Accordingly, the prior art and prevailing aeronautical theory teach away from utilizing upstream/downstream rotors with small blade numbers and/or with a single difference between the number of blades.

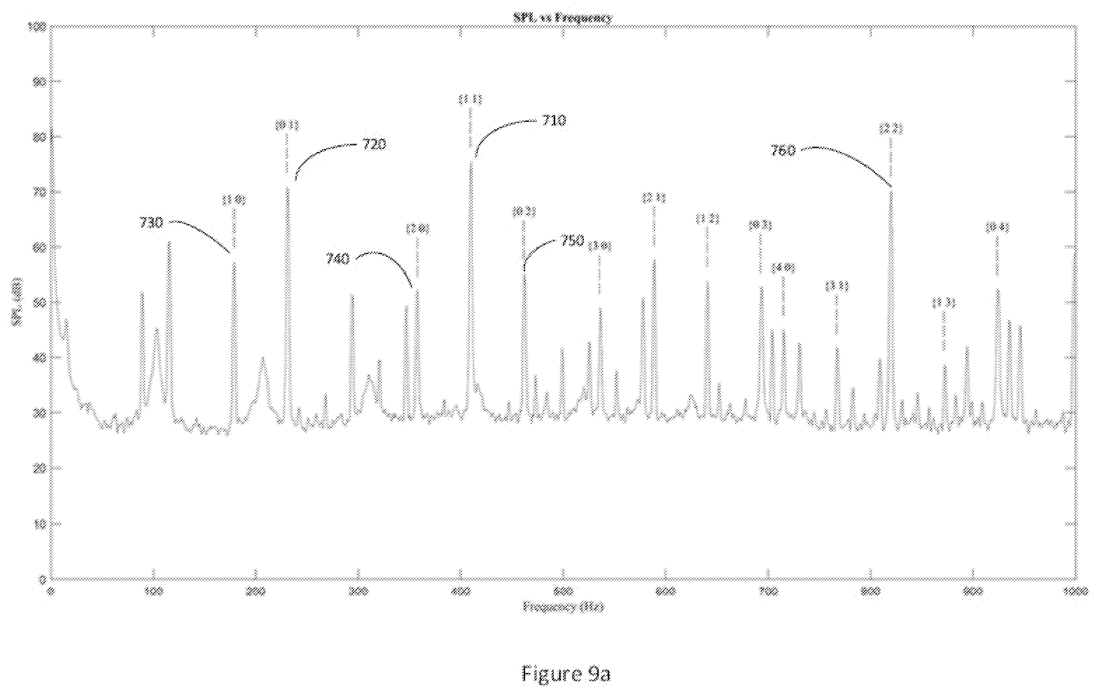

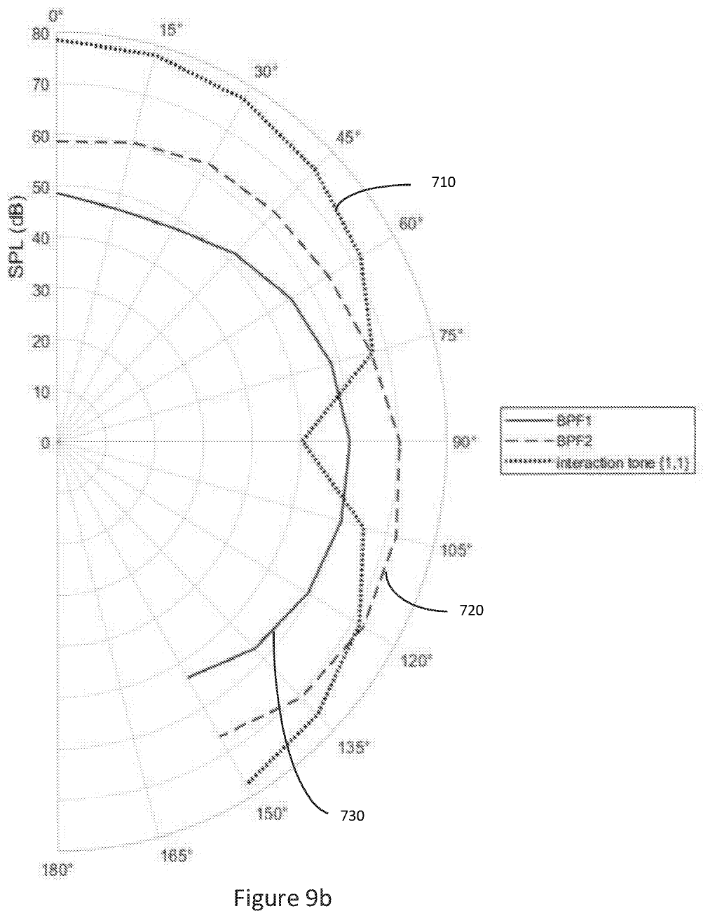

FIG. 9a illustrates a spectrum representative of a noise profile produced by a contra-rotating rotor assembly, showing the sound pressure level (SPL) produced by the rotor assembly at different frequencies. The rotor assembly used to generate noise profile depicted in FIG. 9a included two contra-rotating 12″ rotors separated by 48 mm. The upstream rotor was driven at approximately 5300 RPM, while the downstream rotor was driven at approximately 6800 RPM. Each rotor had exactly two blades. The sound pressure level was acquired at 135° from the axis of the rotors, as UAVs may be typically heard from this angle by people on the ground.

The measured spectrum shows that strong interaction tones are present at certain frequencies, and these interaction tones may predominate the overall noise profile of the UAV. In particular, the {1 1} interaction tone 710 is the strongest interaction tone, with a sound pressure level of approximately 75 dB. Furthermore, the {1 1} interaction tone 710 is louder than each of the individual {0 1} and {1 0} BPF tones 720 and 730, which have respective sound pressure levels of approximately 70 dB and 58 dB. Similarly, the {2 0} and {0 2} BPF tones 740 and 750 have sound pressure levels of approximately 55 dB, while their {2 2} interaction tone 760 has a sound pressure level of 70 dB.

FIG. 9b illustrates the directionality of the first BPF tone 720, the second BPF tone 730, and the {1,1} interaction tone 710. It can be seen that the sound pressure level of each frequency or tone varies with the angle from which the sound pressure level is heard. In particular, the {1,1} interaction tone 710 is loudest close to the axis of the rotor assembly and is reduced by approximately 10-20 dB close to the plane of the rotors. In comparison, the first and second BPF tones 720 and 730 are loudest closest to the plane of the rotors and are comparatively quieter close to the axis of the rotors.

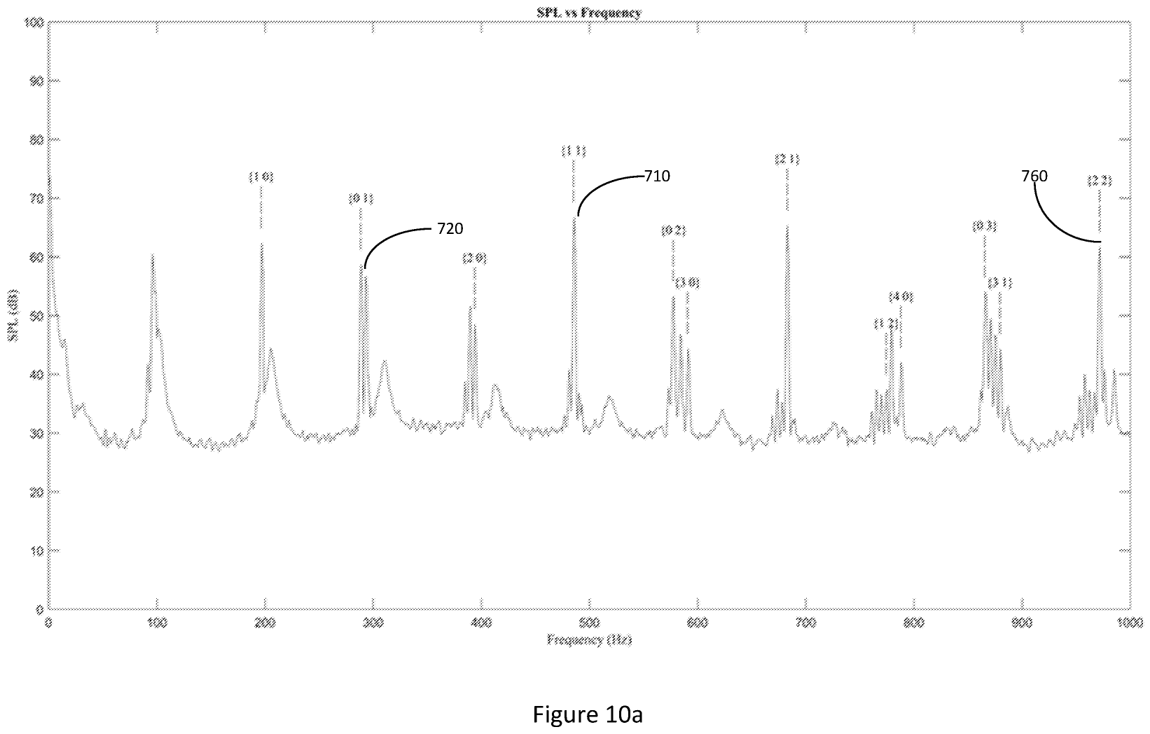

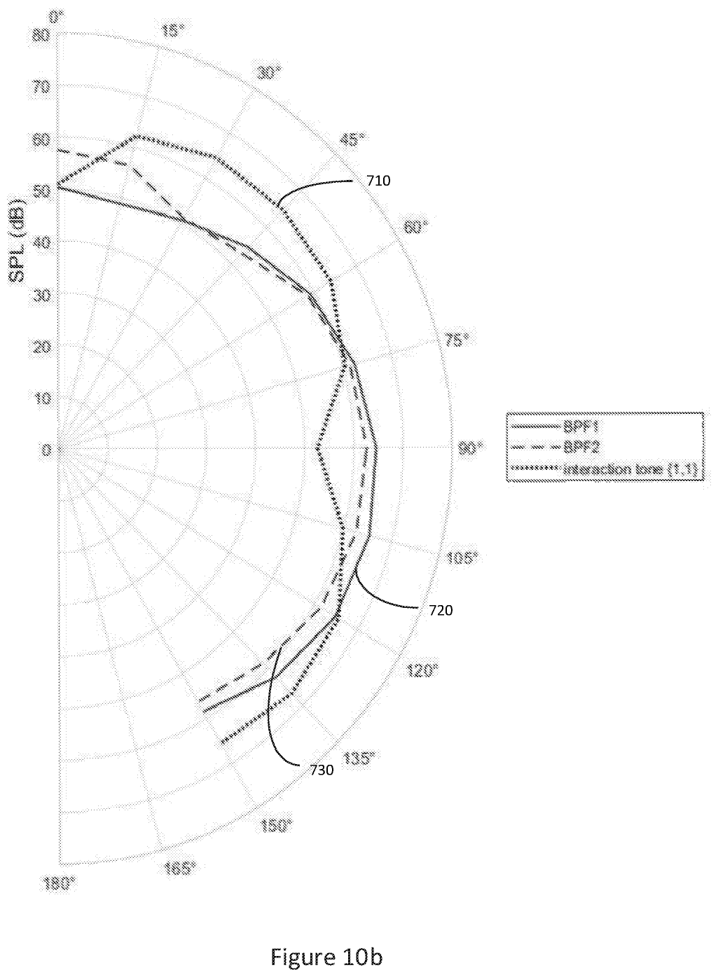

FIG. 10a now illustrates a representative sound profile produced by a contra-rotating rotor assembly including a first rotor having three blades and a second rotor having two blades. The rotor assembly measured in this illustrative example included an upstream rotor having an outer diameter of 12.5″ and three blades, and a downstream rotor having an outer diameter of 12″ and two blades. The upstream rotor was driven at approximately 5800 RPM, while the downstream rotor was driven at approximately 6000 RPM. Both the upstream and downstream rotors were separated by 48 mm.

In this embodiment, the overall sound profile at 135° from the rotor assembly is significantly quieter than the previous two-blade/two-blade embodiment measured in FIG. 9a-b. The sound pressure level of the {1,1} interaction tone 710 has been reduced by approximately 10 dB, while the {2,2} interaction tone 760 has been reduced by approximately 5 dB. Other BPF and interaction tones show similar reductions in their sound pressure levels.

FIG. 10b depicts the directionality of each BPF tone 720 and 730 and the {1,1} interaction tone 710 in FIG. 10a. The sound pressure level of the {1,1} interaction tone 710 is reduced by approximately 30 dB along the axis of the rotors (corresponding to 0°). This is a significant benefit as the axial component of the {1, 1} interaction tone may not be readily addressable through other noise-reduction means, such as damping or shielding by a shroud or cowling. Moreover, the axial component of the noise generated by a rotor assembly may be the loudest or most clearly heard component of the noise when a UAV is flying directly or nearly directly overhead. The {1,1} interaction tone 710 also benefits from 10-20 dB reductions along other non-axial angles, improving the overall noise profile of the UAV.

The overall directionality of the first and second BPF tones 720 and 730 remains largely unchanged, with higher sound pressure levels closer to the rotor plane, although both the first and second BPF tones also benefit from reductions in their sound pressure levels. This may reduce the overall sound pressure produced by the UAV.

It is clear from the above that a rotor assembly having a three-blade/two-blade configuration may offer significant noise reduction compared to two-blade/two-blade or three-blade/three-blade configurations. The applicant has also confirmed that a two-blade/three-blade configuration (i.e. the upstream rotor having two blades and the downstream rotor having three blades) offers the same advantages as the three-blade/two-blade configuration shown here. Although the directionality of the sound profiles have been discussed in the context of the first and second BPF tones 720 and 730 and the {1,1} interaction tone 710, it will be understood that the directionality of the other interaction tones produced by the contra-rotating rotor assembly may benefit from the same advantages that the {1,1} interaction tone 710 experiences. It will be understood that the directionality of the {1,1} interaction tone 710 has presented here out of convenience as it is typically the loudest interaction tone produced by a contra-rotating assembly, and is not intended to be limiting.

With reference to FIG. 6, in some embodiments, the separation 330 between the first rotor 310 and the second rotor 320 may vary between 18 mm to 48 mm. In other embodiments, the separation 330 between the first and second rotors 310 and 320 may be expressed as a proportion of either the first diameter 317 of the first rotor 310 and/or the second diameter 327 of the second rotor 320.

For embodiments employing differing blade numbers for different rotors, the diameter 317 of the first rotor may differ from the diameter 327 of the second rotor, with the first diameter 317 being larger or smaller than the second diameter 327. In other embodiments, the first and second diameters 317 and 327 may be the same.

In some embodiments, either the first and/or second diameter 317 or 327 may be 12″ or 12.5″.

In other embodiments, either the first and/or second diameter 317 or 327 may be 15″. In embodiments where one of the first or second rotors 310 and 320 is upstream of the other rotor, the diameter of the upstream rotor may be 12″-12.5″, while the diameter of the downstream rotor may be 15″. Moreover, in some embodiments, the ratio of the diameter of the upstream rotor to the diameter of the downstream rotor may be within 1:1.05-1:1.5.

In some embodiments, other aspects of the blades 315 and 325 belonging to the first and second rotor 310 and 320 may differ. As a non-limiting example, aerofoil geometry such as the pitch, chord, camber, camber line, angle of attack, and/or thickness of the blades 315 belonging to the first rotor 310 may differ from the blades 325 belonging to the second rotor 320. In some embodiments, the first and second rotor 310 and 320 may be operably coupled or attached to substantially co-axial shafts. In some embodiments, these shafts may be concentric. In other embodiments, these shafts may be separated. In still further embodiments, the separation between the shafts may be less than 10% of either the first diameter 317 of the first rotor 310 and/or the second diameter 327 of the second rotor 320.

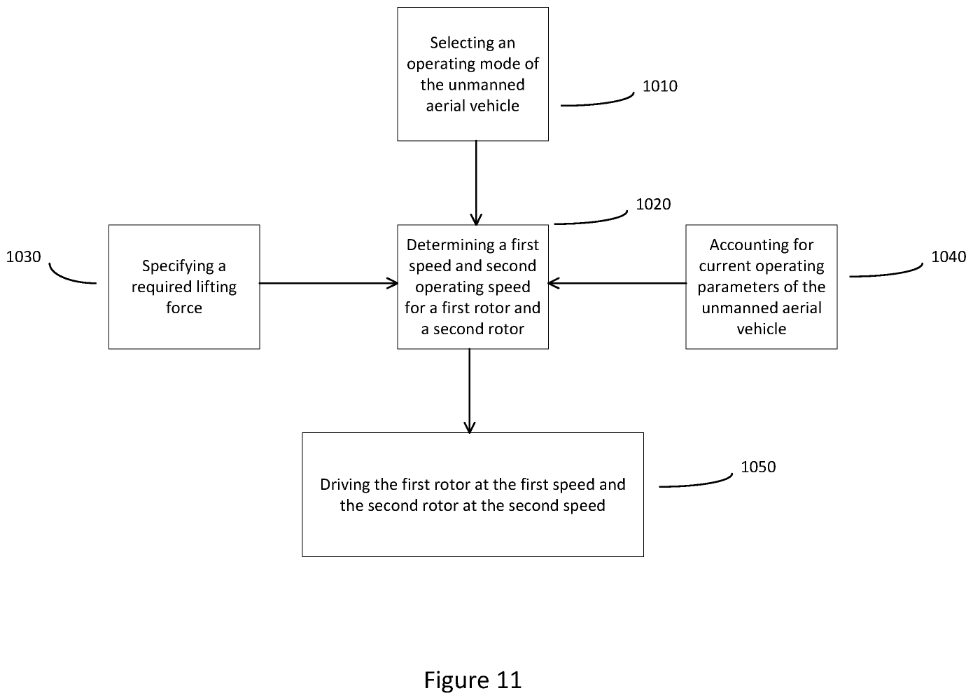

According to a further embodiment, FIG. 11 depicts a method of operating a contra-rotating rotor assembly of an unmanned aerial vehicle. Contra-rotating rotor assemblies may include two or more individual rotors, and the operating characteristics of a contra-rotating assembly, such as its efficiency or the net lift force or noise it produces, are determined by the combined operation of these individual rotors. In contra-rotating rotor assemblies where each individual rotor can be independently driven at different speeds by different motors, a desired output or operating characteristic of the contra-rotating rotor assembly, such as a specified lift force, may be achieved using any one of a large set of individual rotor speed combinations.

However, although one output or operating parameter of the contra-rotating rotor assembly (e.g. lift force) may be substantially the same over a certain set of individual rotor speed combinations, other outputs or operating parameters of the contra-rotating rotor assembly (e.g. efficiency or noise produced) may differ over that same set of individual rotor speed combinations. Given a set of possible rotor speeds which produce a required output (e.g. lift force), it can be useful to choose a combination which results in an optimized efficiency or noise (or other parameter) of the unmanned aerial vehicle, depending on the application or requirements of the unmanned aerial vehicle.

As a non-limiting example, if an unmanned aerial vehicle is being used to record or capture audio, the operator may wish to enable a ‘quiet’ mode where noise produced by the unmanned aerial vehicle is minimized. The operator may directly or indirectly specify a required lift force or thrust, and a combination of individual rotor speeds may be chosen which both satisfies the required lift force or thrust and minimizes the noise produced by the contra-rotating rotor assembly, potentially at the expense of efficiency. Alternatively, an operator may wish to use the unmanned aerial vehicle in a high-efficiency mode, with less of a regard to the noise produced by the unmanned aerial vehicle, and the chosen combination of individual rotor speeds may satisfy the required lift force while operating at a high efficiency.

FIG. 11 depicts a method of operating a contra-rotating rotor assembly of an unmanned aerial vehicle. An operating mode of the unmanned aerial vehicle is selected at 1010 from a group of operating modes. The group of operating modes includes an efficiency mode, a low noise mode, or any combination thereof. The selected operating mode determines to what extent the aerial vehicle is optimized for efficiency or noise.

A first operating speed is determined for an upstream rotor and a second different operating speed is determined for a downstream rotor of the contra-rotating rotor assembly at 1020. The operating speeds are at least partially based on the operating mode selected in 1010, and are determined so that the combined operation of the upstream and downstream rotors at the first and second operating speeds results in an optimized efficiency or noise of the unmanned aerial vehicle.

The first and second operating speeds for the upstream and downstream rotors may also be at least partially determined by a required lift force 1030 which the contra-rotating rotor assembly must produce in order for the unmanned aerial vehicle to maintain its current altitude or ascend or descend to a chosen altitude. The first and second operating speeds for the upstream and downstream rotors may also be at least partially determined by the current operating parameters of the unmanned aerial vehicle and/or the contra-rotating rotor assembly 1040, such as the current speeds of the first and second rotors. This may be used to ensure that the first and second operating speeds determined at 1020 do not differ too significantly from the current speeds of the individual rotors, which could necessitate significant acceleration or deceleration of the individual rotors and could be detrimental to the performance of the unmanned aerial vehicle.

Having determined the first and second speeds at 1020, the upstream and downstream rotors are then driven at the respective first and second operating speeds at 1050.

Contra-rotating rotor assemblies in particular are advantageous for these purposes over other unmanned aerial vehicle propulsion systems. Generally speaking, the noise produced by a contra-rotating rotor system is composed of specific tones and broadband noise. The specific tones correspond to the blade passing frequencies of each rotor and their interaction tones (multiple sums and differences of the blade passing frequencies), while the broadband noise is generated by each individual rotor and the wake interactions between them. Neither of these noises depend on constructively or destructively interfering with noise produced by any other component of the unmanned aerial vehicle, including other separate contra-rotating rotor assemblies or propulsion mechanisms. Similarly, the efficiency of a contra-rotating rotor assembly depends on the speeds of the individual rotors, and may be minimally influenced by other components on the unmanned aerial vehicle. The relationship between the individual rotor speeds and the noise and efficiency of the contra-rotating rotor assembly can therefore be reliably measured ex situ or calculated with minimal regard to other components of the unmanned aerial vehicle, and can be accounted for in a simple and modular fashion.

In some embodiments, the operator may directly or indirectly specify a required lift force or thrust by directly specifying a desired altitude or speed of the UAV through a control apparatus or interface the operator is using to control the UAV. The flight controller on-board the UAV may then convert the desired altitude or speed of the UAV into an equivalent lift force or thrust for the purposes of determining the first and second operating speeds for the upstream and downstream rotors. In other embodiments, the operator may indirectly specify a lift force or thrust by manipulating a control rod or stick or other input device on the control apparatus the operator is using to control the UAV, and the flight controller on-board the UAV may convert the received signal from the controller into a lift force or thrust for the purposes of determining the first and second operating speeds for the upstream and downstream rotors. The direct or indirect specification of a required lift force or thrust may differ depending on the application. In some embodiments, selecting the operating mode at 1010 may be manually specified or initiated by the operator or another party via a user interface or apparatus. As a non-limiting example, the user interface or apparatus may include a typical hand-held radio remote control, or may include a computing device in communication with the UAV. Selecting an operating mode may involve manipulating a physical button or switch on the user interface in some embodiments, or may involve pressing a button or switch on a graphical user interface.

In other embodiments, the operating mode may be selected automatically in response to some internal or external parameter. As a non-limiting example, a geofence or GPS coordinates may be used to automatically select an operating mode when the UAV enters a certain area, e.g. a residential area where noise must be controlled. In these embodiments, an on-board GPS receiver or other circuitry which enables GPS function may be installed in or on the UAV. As a further non-limiting example, the UAV may automatically select an operating mode based on its remaining battery charge level or power, e.g. automatically engaging a high-efficiency mode when its battery is critically low.

In some embodiments, the operating mode may optimize the unmanned aerial vehicle for one operating parameter without regard to another operating parameter, e.g. the UAV may be optimized for noise regardless of the resulting efficiency. In other embodiments, the operating mode may optimize the UAV for one operating parameter, while restricting another parameter to an acceptable range or threshold. As a non-limiting example, the operating mode may optimize efficiency while ensuring that the noise produced by the UAV assembly does not exceed a certain value. As a further non-limiting example, the operating mode may optimize noise while maintaining a minimum efficiency of the contra-rotating rotor apparatus.

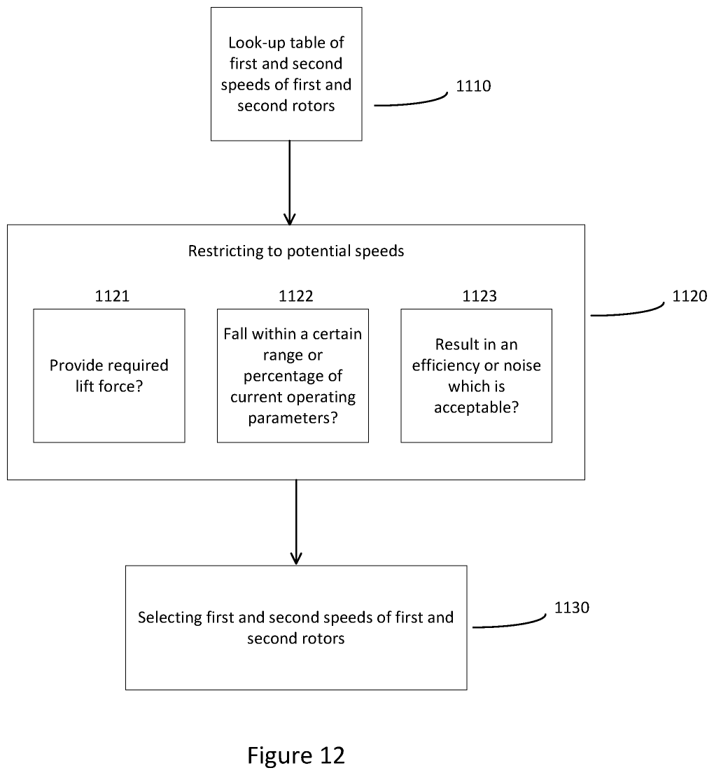

FIG. 12 depicts a method of determining the first and second operating speed of the upstream and downstream rotors according to some embodiments. In these embodiments, the resultant lift force or thrust, efficiency, and noise produced by a contra-rotating rotor assembly may be known for a set of upstream and downstream rotor speeds, as shown in 1110. To determine what speeds the upstream and downstream rotor should be operated at according to the selected operating mode, the known set of upstream and downstream rotor speeds may be restricted to a narrower set of potential speeds, as shown in 1120. The known set of upstream and downstream rotor speeds may be restricted to a set of rotor speeds based on:
a predetermined range of the required lift force or thrust (1121); and/or
a predetermined range or percentage of one or more current operating parameters of the unmanned aerial vehicle (1122); and/or
a predetermined efficiency range or a predetermined noise level range based on the operating mode (1123)

Any or all of these restrictions may be imposed on the initial set of known upstream and downstream rotor speeds in any order or in any combination, depending on the requirements of the unmanned aerial vehicle or the operator. In some embodiments, some or all of these restrictions may be optional. As a non-limiting example, the UAV may be optimized for efficiency without the noise being constrained to an acceptable range or threshold specified by the operating mode, meaning the restriction at 1123 would be unnecessary.

In some embodiments, the predetermined efficiency range may be a range between a minimum efficiency and a maximum efficiency. As a non-limiting example, the efficiency range may be specified to be between 70% and 100%. In other embodiments, the efficiency range may be a certain percentage above or below a specified efficiency. As a non-limiting example, the efficiency range may be within +/−10% of a specified efficiency. The efficiency range used to restrict the set of rotor speeds may vary depending on the application. Likewise, in some embodiments, the predetermined noise level range may be a range between a minimum noise and a maximum noise. As a non-limiting example, the noise range may be specified to be between 0 dB and 70 dB. In other embodiments, the noise level range may be a certain percentage above or below a specified noise level. As a non-limiting example, the noise level range may be within +/−10% of a specified noise level measured in decibels. The noise level range used to restrict the set of rotor speeds may vary depending on the application.

Once the set of upstream and downstream rotor speeds has been restricted by the applicable criteria at 1120, the optimized first and second operating speeds are chosen from the remaining combinations based at least partially on the selected operating mode of the UAV, as in 1130.

In some embodiments, the known set of upstream and downstream rotor speeds and their resultant lift forces or thrusts may be stored in a look-up table. This look-up table may be stored in the digital memory of a computing device, such as a handheld device, a personal computer, or on-board the UAV itself. In other embodiments, the upstream and downstream rotor speeds may be stored as a contour plot in the digital memory of a computing device. A contour from this plot may correspond to a constant lift force or thrust for a set of combined upstream and downstream rotor speeds, from which the optimized first and second operating speeds may be chosen. The known set of upstream and downstream rotor speeds, and their associated lift force or thrust, noise, and efficiency values can be stored and utilized depending on the application.

In some other embodiments, the first and second operating speed of the upstream and downstream rotors may be at least partially determined by an algorithm, curve fitting, or computational modelling. This may involve modelling the behavior of the contra-rotating rotor assembly or unmanned aerial vehicle given a hypothetical upstream and downstream rotor speed. This may also involve extrapolating from a known relationship or partial dataset describing the relationship between the upstream and downstream rotor speeds and the contra-rotating rotor assembly or the unmanned aerial vehicle. For example, a required lift force may be specified, and the behavior of the contra-rotating rotor assembly modelled to predict what set of upstream and downstream rotor speeds would satisfy that lift force. The remaining parameters of the contra-rotating rotor assembly or unmanned aerial vehicle (e.g. noise, efficiency, etc.) could also be modelled, and a combination of rotor speeds could be selected which satisfies the criteria imposed by the established operating mode.

The process of restricting and selecting the upstream and downstream rotor speeds as depicted in FIG. 12, or other embodiments of determining the first and second operating speeds of the upstream and downstream rotors, may be performed using one or more digital computing devices, such as a handheld device, a control apparatus or interface the operator is using to control the UAV, on-board the UAV itself, or at a computing device or other suitable device which the UAV or control apparatus is in communication with. In particular, embodiments where the first and second operating speed of the upstream and downstream rotors are at least partially determined using computationally-intensive methods such as computational modelling may be better suited to external computers which are in communication with the UAV, depending on the computing resources of the on-board circuitry of the UAV or the control apparatus.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative assembly and method, and illustrative examples shown and described. Accordingly, departures may be made from such details without departure from the spirit or scope of the Applicant's general inventive concept.

1. An unmanned aerial vehicle (UAV), the UAV including:
a first rotor, the first rotor having a diameter and a first number of blades; and
a second rotor, the second rotor having a diameter and a second number of blades;
wherein the first and second rotor are substantially coaxial;
and wherein the first number of blades and the second number of blades are not the same number and are both more than one.

2. The unmanned aerial vehicle of claim 1, wherein the first number of blades is two and the second number of blades is three.

3. The unmanned aerial vehicle of claim 1, wherein the first rotor is upstream of the second rotor.

4. The unmanned aerial vehicle of claim 1, wherein the second rotor is upstream of the first rotor.

5. The unmanned aerial vehicle of claim 1, wherein the diameter of the first rotor and the diameter of the second rotor are different.

6. The unmanned aerial vehicle of claim 1, wherein the ratio of the diameter of the first rotor to the diameter of the second rotor is within 1:1.05-1:5.

7. The unmanned aerial vehicle of claim 1, wherein the ratio of the diameter of the second rotor to the diameter of the first rotor is within 1:1.05-1:1.5.

8. The unmanned aerial vehicle of claim 1, wherein the diameter of the first rotor is about 12″-12.5″ and the diameter of the second rotor is about 15″.

9. The unmanned aerial vehicle of claim 1, wherein the diameter of the second rotor is about 12″-12.5″ and the diameter of the first rotor is about 15″.

10. The unmanned aerial vehicle of claim 1, wherein the diameter of the first rotor and the diameter of the second rotor are about the same.

11. The unmanned aerial vehicle of claim 1, wherein a pitch, chord, camber, camber line, angle of attack, and/or thickness of a blade of the first rotor differs from that of a blade of the second rotor.

12. The unmanned aerial vehicle of claim 1, wherein the first rotor and second rotor are contra-rotating.

13. The unmanned aerial vehicle of claim 1, further comprising one or more speed controllers configured to rotate the first and second rotors at different speeds.

14. The unmanned aerial vehicle of claim 1, further comprising a shroud at least partially surrounding the first rotor and/or the second rotor.

15. A method for operating a contra-rotating rotor assembly of an unmanned aerial vehicle (UAV), the method including:
selecting an operating mode from the group consisting of an efficiency mode, low noise mode or any combination thereof;
determining a first operating speed for an upstream rotor and a second different operating speed for a contra-rotating downstream rotor, wherein the first operating speed and the second operating speed are based on the selected operating mode; and
driving the upstream rotor at the first operating speed and the contra-rotating downstream rotor at the second operating speed.

16. The method of claim 15, wherein the operating mode is selected automatically in response to an internal or external parameter.

17. The method of claim 16, wherein the internal or external parameter is one or more of a geofence, a GPS coordinate of the unmanned aerial vehicle, or a charge level of a battery of the unmanned aerial vehicle.

18. The method of claim 15, wherein the first operating speed and the second operating speed are based on:
a predetermined range of a required lift force; and/or
a predetermined range of a current operating parameter of the unmanned aerial vehicle; and/or
a predetermined efficiency range or a predetermined noise level range based on the operating mode.

19. The method of claim 15, wherein the first operating speed and second operating speed are determined using a look-up table, a contour plot, algorithm, curve fitting, or computational modelling.

20. The method of claim 15, wherein the first and second operating speed are determined on-board the unmanned aerial vehicle, remotely using a remote control apparatus or interface, or remotely using a computer device in communication with the unmanned aerial vehicle.
